(19) United States
(12) Patent Application Publication
(10) Pub. No.: US 2023/0272506 A1
(43) Pub. Date: Aug. 31, 2023

(54) AN INTEGRATED HEAP LEACH PROCESS

(71) Applicants: ANGLO AMERICAN TECHNICAL & SUSTAINABILITY SERVICES LTD, London (GB); ANGLO CORPORATE SERVICES SOUTH AFRICA (PTY) LTD, Rosebank (ZA)

(72) Inventors: Anthony Owen FILMER, Kangaroo Point (AU); Christopher Alan BILEY, London (GB); Daniel John ALEXANDER, St Albans (GB)

(21) Appl. No.: 18/014,968

(22) PCT Filed: Jul. 16, 2021
(86) PCT No.: PCT/IB2021/056429

§ 371 Date: Jan. 6, 2023

Related U.S. Application Data
(60) Provisional application No. 63/053,104, filed on Jul. 17, 2020.

(51) Int. Cl. C22B 11/00; C22B 1/24; C22B 3/08; C22B 3/26

(52) U.S. Cl. CPC C22B 11/04; C22B 1/24; C22B 3/08; C22B 3/33

(57) ABSTRACT

THIS invention relates a method for processing a sulphide ore containing metal values comprising the integration of a sand heap leach (10) and a flotation process (12), providing a method which is suited to processing ores with significant quantities of leachable sulphides. The method includes a comminution step (14), and the classification of the comminuted ore into an oversize coarse fraction (16), a fine fraction (18) suitable for fine flotation and optionally an intermediate fraction (20) suitable for coarse flotation. A concentrate (30) containing iron sulphides from a fine flotation step (22) and optionally a concentrate (36) from a coarse flotation step (34) are blended with the oversize coarse fraction (16), to obtain a blended ore (39) is stacked and subjected to a heap leach process (40).

### BACKGROUND TO THE INVENTION

Heap leaching has long been applied to the recovery of copper from secondary and oxidised copper ores, where the predominant copper minerals are readily soluble in acid. Soluble mineral species in such ores include chalcocite, covellite and oxides like malachite.

The principal advantage of the heap leach, when considered relative to the flotation alternative, is the lack of fine grinding required prior to the heap leach. Depending on grade, the ore is crushed to an upper size of around 0.5 m for dump or heap leaching, down to around 15 mm for ore agglomeration and heap leaching. Typical heap leach recoveries from secondary copper ores range from around 65% for coarsely crushed rock up to around 80% for agglomerated finely crushed ore. This recovery is usually lower than the alternative flotation where recoveries are typically significantly above 80%.

Despite widespread applications for acid heap leaching of secondary copper, the heap leaching of primary copper ores has never been applied commercially. This is due to the very slow dissolution of chalcopyrite that occurs under conditions achievable in a conventional heap leach. The closest approximation to a commercial processing by heap leaching a primary copper ore is opportunistic recovery of copper that dissolves within a low-grade ore dump, where copper extractions can average around 25%. For ores such as primary copper, and transition between secondary and primary, fine grinding and flotation has been the preferred production route.

Heap leaching of nickel sulphide ores is also problematic due to both slow leaching of the nickel sulphides and high acid consumptions by the gangue constituents associated with nickel sulphide ores.

Proponents of heap leaching of primary copper ores have tested at laboratory and pilot scale a variety of different approaches to overcome the slow leaching of chalcopyrite.

The ability to dissolve chalcopyrite under oxidizing conditions in laboratory columns at temperatures above 50° C. is well known (Minerals Engineering; Volume 15, Issue 11, November 2002, Pages 777-785). Mintek Heapstar™ have modelled heat generation and distribution within conventional heaps containing primary copper ores, in an attempt to design and control the heaps to generate the temperatures within the heap, at which the chalcopyrite will dissolve. In WO2004/027099 Crundwell has claimed a heap control system to improve heat retention.

However, the large-scale trial heaps used to test these designs have only achieved sufficient heating in part of the heap and find the temperature difficult to sustain through the leaching duration time, yielding copper extractions of around 50%. In summary, maintaining the elevated temperatures throughout the heap, for the extended period of a few years whilst the necessary diffusional and chemical reactions inherent in heap leaching of chalcopyrite reach high levels of extraction, has proved elusive.

US 6,802,888 has followed a different approach, to achieve a thermal heap leach. This involved grinding of the ore to a fine size to recover a primary copper concentrate by flotation, grinding this concentrate to a fine size, and then agglomerating the concentrate on a substrate of pebbles. This patent describes leaching of a finely ground chalcopyrite concentrate at an acceptable rate and total extraction. Temperatures achievable through the oxidation of the copper concentrate are upwards of 70° C., and extractions at these temperatures are around 90% within a hundred days. However, the principal advantage of heap leaching, the lack of high cost fine grinding, has been voided by the need to first generate the fine copper concentrate from the ore. Utilising the teachings of US 6,802,888, copper losses occur in both the flotation and leaching parts of the envisaged process. As such, it remains preferable to smelt the copper flotation concentrate, rather than re-agglomerating it together with acid and pebbles, and leaching the mix to recover the copper metal.

In a separate patent relating to gold recovery from pyrite, US 6,146,444 (Kohr) crushes the gold containing ore to between 6-20 mm, and then uses heap leaching on the ore fraction > 1 mm coarse fraction of the ore to liberate the gold by partially oxidizing the pyrite. This biooxidation of pyrite, which is reasonably easily oxidised and where complete oxidation is not essential because gold is the metal of interest, is well established. Gold in the fine fraction from the initial classification by Kohr is recovered separately to the heap leach, by agitation leaching of the fines. To maximise the recovery of gold locked in pyrite, Kohr separates the pyrite from the fines, and combines or spreads this pyrite enriched fraction to form a layer on the coarser fraction of the ore in the heap. The relatively fine pyrite enriched layer on the surface of the heap is bio-oxidised by the leachant with access to surrounding air as the oxidant, liberating more gold, without significantly affecting the conditions of the heap leach of the underlying heap. Once the pyrite from both the concentrate and coarse fractions in the heap is partially oxidised by heap leaching and the locked gold is liberated, the residual heap leached ore, including the partially oxidised pyrite, is ground to liberate the remaining gold, and agitation leached. Effectively, the bioleaching of the pyrite fraction is an alternative to pressure oxidation or roasting of the pyrite fraction, as practiced elsewhere. The recoverable gold from the 6-20 mm fraction, after heap leaching and grinding to less than 75 microns, increases from less than 50% to greater than 90%.

To overcome the slow leaching of chalcopyrite in primary copper ores, various novel leachants including acidic copper chloride, ammonium chloride and glycine have been proposed as alternatives for heap leaching of primary copper ores. All these reagents will dissolve exposed copper if it is exposed in the heap. But none of these higher cost leachants have yet found commercial success, largely due to excessive reagent costs and modest extractions achieved in conventional heap leaching.

With respect to flotation of sulphide ores, the concept of a tradeoff between grade and recovery is well known. By changing conditions in flotation, one can achieve high flotation recoveries, but the grade of the concentrate is lower than that required for subsequent processing. Alternatively, one can sacrifice flotation recovery and achieve high grade concentrates.

As an example, FIG. 2 in (Otunniyi, I.O., Oabile, M., Adeleke, A.A. et al. Copper activation option for a pentlandite-pyrrhotite-chalcopyrite ore flotation with nickel interest. Int J Ind Chem 7, 241-248 (2016)) shows the ability to generate a high recovery of nickel, but at a low grade of concentrate, or a high grade of nickel but at a low recovery. Similar trends apply in copper and zinc flotation.

To meet the specifications of the downstream smelting process, potential flotation recovery is forfeited. In the usual rougher-cleaner configuration of flotation, the rougher stage is often used to maximise recovery of all sulphides, and the second cleaning stage to meet acceptable grade albeit at lower recovery. This is by adjusting flotation conditions in the cleaning stage to reject the iron sulphides and remaining gangue including many composite particles containing both gangue and values. The reject stream from cleaning, cleaner tails, has an elevated level of values relative to the ore, and a high sulphide content.

The potential to further process these cleaner tailings is limited due to its low grade and difficulty in separating the valuable sulphides from the iron sulphides. Where further recovery of the cleaner tailings is practiced, the most common process is to scavenge the sulphides for reintroduction to the rougher flotation, with regrind either before or after the scavenger flotation stage to further liberate and separate the values from the composite particles. But the underlying issue of grade-recovery tradeoff in the overall system remains.

For nickel in particular, this is problematic as a significant proportion of nickel is present in solid solution with the iron sulphides.

This increased recovery in flotation is one problem that is addressed by the current invention. The second problem to be addressed is to increase the temperature and decrease acid consumption in the heap leach, such as to recover more of the valuable refractory sulphides.

### SUMMARY OF THE INVENTION

A first embodiment of the invention relates to a method for processing a sulphide ore containing metal values in which:
the ore is comminuted (14) to a P₈₀ from 0.5 to 15 mm, preferably from 1 to 10 mm, preferably from 2 to 8 mm, typically from 2 to 6 mm, and classified:
into a fraction (18) with a particle size P₈₀ of less than 0.25 mm suitable for fine flotation; and
an oversize fraction (16);
the fraction (18) suitable for fine flotation is subjected to fine flotation (22) to produce a concentrate product (24) containing metal values and residue (26) which is subjected to a scavenging sulphide float (28) to produce a concentrate (30) containing metal sulphide values and iron sulphides, and a fine flotation residue (32);
the concentrate (30) containing iron sulphides or a leached residue thereof and possibly including concentrate product (24) from the fine flotation (22), is blended with the oversize fraction (16) to obtain a blended ore (39); and
the blended ore (39) is stacked and subjected to a heap leach process (40) in which the heap is irrigated with a leachant to obtain a pregnant leachate containing metal values.

The ore typically contains sulphides containing copper, nickel, zinc, and/or gold value metals, including ore with gold as a primary or coproduct.

Preferably, the oversize fraction (16) from the classification has a particle size P₈₀ up to 15 mm, preferably up to 10 mm, preferably up to 8 mm, typically up to 6 mm

The fraction (18) suitable for fine flotation preferably has a particle size P₈₀ of 0.1 to 0.25 mm, typically 0.15 to 0.2 mm.

The fraction (18) suitable for fine flotation may comprise 10 to 35%, typically 15 to 25% by weight of the comminuted ore, and the oversize fraction (16) comprises 90 to 65%, typically 85 to 75% by weight of the comminuted ore.

The residue (26) is typically subjected to the scavenging sulphide float at a modified pH of about 4 to 5, to produce the concentrate (30) typically containing 4 to 6% of the mass of the ore.

The concentrate (30) containing iron sulphides typically has a particle size P₈₀ of 0.1 to 0.25 mm microns, typically 0.15 to 0.2 mm, and a sulphur grade of 5 to 35%, typically 10 to 35%, usually 10 to 25%, or 10 to 20% by weight.

Preferably, the blended ore (39) has a sulphur content of greater than 1% and preferably greater than 2%, by weight.

The concentrate (30) and possibly including concentrate product (24) from the fine flotation (22), is preferably blended with the oversize fraction (16) in an amount to limit the amount of particles with a size <75 microns, to less than 10%, preferably less than 7% by weight in the blended ore (39).

Preferably, the stacked blended ore (39) is sufficiently permeable to irrigation at greater than 0.5 L/m²/h, and typically 1 L/m²/h or greater, for example up to 10 L/m²/h.

A second embodiment of the invention relates to a method for processing a sulphide ore containing metal values in which:
the ore is comminuted (14) to a P₈₀ from 0.5 to 15 mm, preferably from 1 to 10 mm, preferably from 2 to 8 mm, typically from 2 to 6 mm, and classified:
into a fraction (18) with a particle size P₈₀ of less than 0.2 mm suitable for fine flotation;
a fraction (20) with a particle size P₈₀ of greater than 0.2 mm and less than 1 mm suitable for coarse flotation;
and an oversize fraction (16);
the fraction (18) suitable for fine flotation is subjected to fine flotation (22) to produce a concentrate product (24) containing metal values and residue (26) which is subjected to a scavenging sulphide float (28) to produce a concentrate (30) containing some metal sulphide values and iron sulphides, and a fine flotation residue (32);
the fraction (20) suitable for coarse flotation is subjected to coarse flotation (34) to obtain a coarse flotation product (36) containing metal values, and a coarse flotation residue (38); and
the concentrate (30) containing iron sulphides or a leached residue thereof and possibly including concentrate product (24) from the fine flotation (22) is blended with the oversize fraction (16) to obtain a blended ore (39); and
the blended ore (39) is stacked and subjected to a heap leach process (40) in which the heap is irrigated with a leachant to obtain a pregnant leachate containing metal values.

The ore typically contains sulphides containing copper, nickel, zinc, and/or gold value metals, including ore with gold as a primary or coproduct.

The oversize fraction (16) from the classification typically has a particle size P₈₀ up to 15 mm, preferably up to 10 mm, preferably up to 8 mm, typically up to 6 mm.

Preferably, the fine fraction (18) suitable for fine flotation has a particle size P₈₀ of 0.1 to 0.25 mm microns, typically 0.15 to 0.2 mm.

Preferably, the oversize fraction (20) suitable for coarse flotation has a particle size P₈₀ from 0.15 to 0.5 mm microns, typically 0.2 to 0.4 mm, or 0.25 to 0.35 mm.

The fraction (18) suitable for fine flotation typically comprises 10 to 35% typically 15 to 25% by weight of the comminuted ore, the oversize fraction (20) suitable for coarse flotation comprises 5 to 15%, typically 8 to 12% by weight of the comminuted ore, and the oversize fraction comprises 85 to 50%, typically 77 to 63% by weight of the comminuted ore.

The residue (26) is typically subjected to the scavenging sulphide float at a modified pH of about 4 to 5, to produce the concentrate (30) typically containing 4 to 6% of the mass of the ore.

Typically, the concentrate (30) containing iron sulphides has a particle size P₈₀ of 0.1 to 0.25 mm, typically 0.15 to 0.2 mm, and a sulphur grade of 5 to 35%, typically 10 to 35%, usually 10 to 25%, or 10 to 20% by weight.

The blended ore (39) preferably has a sulphur content of greater than 1% and preferably greater than 2%, by weight.

The concentrate (30) containing iron sulphides and possibly including concentrate product (24) from the fine flotation (22), and all or a portion of the coarse flotation product (36) may be blended with the oversize fraction (16), to obtain the blended ore (39).

The concentrate (30) containing iron sulphides and possibly including concentrate product (24) from the fine flotation (22), may be blended with all or a portion of the coarse flotation product (36), and then blended with the oversize fraction (16) to obtain a blended ore (39).

Preferably, the concentrate (30) containing iron sulphides and possibly including concentrate product (24) from the fine flotation (22), is blended with the coarse flotation product (36) and the oversize fraction (16) in an amount to limit the amount of particles with a size <75 microns, to less than 10%, preferably less than 7% by weight in the blended ore (39).

The concentrate (30) containing iron sulphides is preferably blended with the coarse flotation product (36) and the oversize fraction (16) in an amount to limit the amount of particles with a size <0.075 mm, to less than 10%, preferably less than 7% in the blended ore (39).

Preferably, the stacked blended ore (39) is sufficiently permeable to irrigation at greater than 0.5L/m²/h, typically 1L/m²/hor greater for example up to 10L/m²/h.

The concentrate (30) containing iron sulphides may be blended with all or a portion of the coarse flotation product (36), and then blended with the oversize fraction (16) to obtain the blended ore (39).

The concentrate (30) containing iron sulphides may be blended with all or a portion of the coarse flotation product (36) and the blend is leached in agitated tanks to generate a residue containing elemental sulphur and iron sulphides which is blended with the oversize fraction (16).

The heap leach process may be a biooxidation leach process, or a chemical leach process.

In an embodiment where the heap leach is a biooxidation leach process, the heap is inoculated with thermophilic microorganisms and irrigated with a leachant such as a sulphuric acid containing raffinate from a solvent extraction process. Typically, the pH of the leachant is less than 2.5 and preferably less than 2, and heap has an internal temperature of between 50-85° C., typically between 60-80° C.

In an embodiment where the heap leach is a chemical leach process, the heap is irrigated with a leachant comprising for example cyanide to dissolve gold, or copper chloride to dissolve chalcopyrite.

Preferably, the fine flotation concentrate (24) has a grade specifically optimised to meet the specifications required for subsequent smelting.

The size of the comminution for a specific ore may be selected to recover sufficient sulphide flotation concentration, to reduce the acid requirement of the heap leach to less than 10 kg/tonne ore, and preferably less than 5 kg/tonne.

Using the method of the present invention, losses of values to the flotation residue may be reduced to less than 15%, and preferably less than 10%, and even more preferably around 5%.

The products generated are typically a saleable metal sulphide concentrate and a metal cathode.

The valuable metal sulphide concentrate formed may be added to the heap leach for conversion to a metal cathode.

The valuable metal concentrate or the predominantly iron sulphide concentrate may be partially or mostly leached external to the heap, and the leach residue from this external leaching is added back to the heap.

The thermally assisted heap leach typically requires less than 300 days, and preferably less than 150 days, and even more preferably less than 100 days.

The heap leach may be carried out on a dynamic leach pad, in which at least part of the infrastructure is fixed.

The temperature of the heap may be adjusted and controlled using one or more of the irrigation rate, aeration rate, and concentrate blending rate during construction of the heap.

As mentioned above, the method of the invention makes use of a “fine flotation” process preferably in combination with a “coarse flotation” process.

In a conventional or “fine flotation” process, particle sizes are typically less than 0.1 mm. The ore particles is mixed with water to form a slurry and the desired mineral is rendered hydrophobic by the addition of a surfactant or collector chemical. The particular chemical depends on the nature of the mineral to be recovered. This slurry of hydrophobic particles and hydrophilic particles is then introduced to tanks known as flotation cells that are aerated to produce bubbles. The hydrophobic particles attach to the air bubbles, which rise to the surface, forming a froth. The froth is removed from the cell, producing a concentrate of the target mineral. Frothing agents, known as frothers, may be introduced to the slurry to promote the formation of a stable froth on top of the flotation cell. The minerals that do not float into the froth are referred to as the flotation tailings or flotation tails. These tailings may also be subjected to further stages of flotation to recover the valuable particles that did not float the first time. This is known as scavenging.

In a “coarse flotation” process partially ground ore is classified to produce a sand fraction with a particle size typically greater than 0.15 mm, which is beneficiated using a fit for purpose flotation machine such as the Eriez Hydrofloat™. The Eriez Hydrofloat™, carries out the concentration process based on a combination of fluidization and flotation using fluidization water which has been aerated with micro-bubbles of air. The flotation is carried out using a suitable activator and collector concentrations and residence time, for the particular mineral to be floated. At this size, the ore is sufficiently ground to liberate most of the gangue and expose but not necessarily fully liberate the valuable mineral grains.

### BRIEF DESCRIPTION OF THE DRAWINGS

FIG. 1 is a block flow sheet of an integrated heap leach process of the present invention;

FIG. 2 reflects graphs showing the various forms of losses occurring in flotation processes;

FIG. 3 is a graph showing the recovery entitlement of flotation and heap leaching versus particle size;

FIG. 4 is a graph showing the oxygen consumption and solution potential during a column bioleach of ore prepared as a sand; and

FIG. 5 is a graph showing the solution-based copper extractions during column bioleaching of ore prepared as a sand.

### DETAILED DESCRIPTION

THIS invention relates to the integration of a sand heap leach and a flotation process, providing a system which is suited to processing ores with significant quantities of leachable sulphides.

The closest practice to production of both a concentrate and cathode has been claimed in the heap leach concept developed by Geobiotics (Harvey et. al., Thermophilic Bioleaching of Chalcopyrite Concentrates with GEOCOAT™ Process, Presented at Alta 2002 Nickel/Cobalt 8 - Copper 7 Conference, Perth, Australia), in which a final copper flotation concentrate has been coated on a substrate, and this coated substrate has subsequently been heap leached. No benefits accrue to the flotation process. The concept of utilising an integrated system for utilising heap leaching to improve values recovery during flotation; and flotation to improve values recovery during heap leaching, has not previously been elucidated.

The system that forms the subject of the current invention utilises the blending of some of a flotation concentrate, to generate heat within the heap leach and hence accelerate heap leaching, and in so doing, enable an increase in values recovery from the ore fraction assigned to flotation, by processing a low grade concentrate in the heap leach.

In its most preferred embodiment, the system utilises biologically enhanced leaching conditions, as is well established for copper, nickel and uranium ores.

The biologically enhanced leaching system is particularly suited to ores where leaching of the values is slow such as primary copper and nickel sulphide ores, as temperature generated by the oxidation particularly of the more reactive iron sulphide content of the low-grade concentrate, aids leach recovery of the primary values from both the coarse fraction of ore from classification and the low grade concentrate. An example is a primary copper ore, where the pyrite content of the low grade concentrate, which is much more reactive than chalcopyrite, helps enhance the heap temperature and the slower leaching chalcopyrite leaching rate is enhanced. A second example is in a mafic nickel sulphide, where the availability of reactive pyrrhotite in the low grade concentrate accelerates the leaching rate of the slower leaching pentlandite.

The biologically enhanced system is also particularly suited to heap leaching where acid consumptions are high such as in nickel and some copper ores, as much of the acid consuming gangue present in the ore deports to the finer fraction and can be rejected as flotation tailings, and the oxidation of the additional sulphides from the low grade iron sulphide rich concentrate can generate acid throughout the heap; or for ores where flotation recoveries are low such as nickel and copper/gold ores; particularly if significant values are associated with the iron sulphides in the ore. For such ores, the current invention can liberate the contained values from the iron sulphides, or where co-extraction of metals by heap leaching is difficult due to reagent consumption such as copper gold ores where high extractions of copper can precede the heap leaching of gold.

Even when the heap leach component utilises a leaching technique which does not oxidise the iron sulphides, the composite particles such as those with iron sulphides, that would have been rejected by flotation, are exposed for heap leaching.

As such the invention is applicable to almost all sulphide containing ores, in which rapid and cost-effective heap leaching is desirable, including copper, nickel, gold, zinc and uranium ores. The system encompasses comminution and classification to produce a fine and coarse fraction of the ore. The fine fraction of ore is floated, in a configuration that enables increased the recovery of the valuable metal relative to conventional flotation recovery from that ore fraction. The coarse fraction of the ore is heap leached, in a configuration such that the heap leach recovery benefits from the flotation of the fines. Recoveries using the invention are higher than can be achieved by conventional heap leaching of the same ore, or by conventional flotation of the ore. In so doing, the partial processing by flotation and heap leaching generate synergistic effects for the parallel processing route.

The system typically utilises a low grade and iron sulphide rich concentrate formed from the flotation of the fine fraction of comminuted ore. This sulphide rich concentrate is recovered separately by flotation under different conditions to the flotation of the high grade sulphide concentrate, selected such that most of the iron sulphides float. The iron rich concentrate is blended back into the coarse ore fraction prior to heap leaching, to heat and control the heap leach temperature. Through this blending and subsequent biooxidation, the thermal value of the sulphides can raise the temperature of the whole heap. The sulphide content includes the quite reactive sulphide gangue minerals such as pyrite and pyrrhotite; and will include some or most of the valuable metal that previously failed to report to the main flotation concentrate. As an example, where the valuable metal is copper, the main concentrate may contain 28% Cu, and the low grade concentrate contains 1-3% Cu, as well as most of the 2% of pyrite that was present in the ore. i.e. around 15% pyrite in the low grade concentrate.

The low grade concentrate is blended into the sand prior to heap formation, for example by simple mixing the two feed streams in the feed to the stacker, or by agglomeration of the fines onto the coarser sand using an agglomeration drum. The blended ore is then leached to recover the copper or other values. The pyrite that is present in the low grade concentrate is also oxidised contributing heat and acid to assist the leaching of the copper.

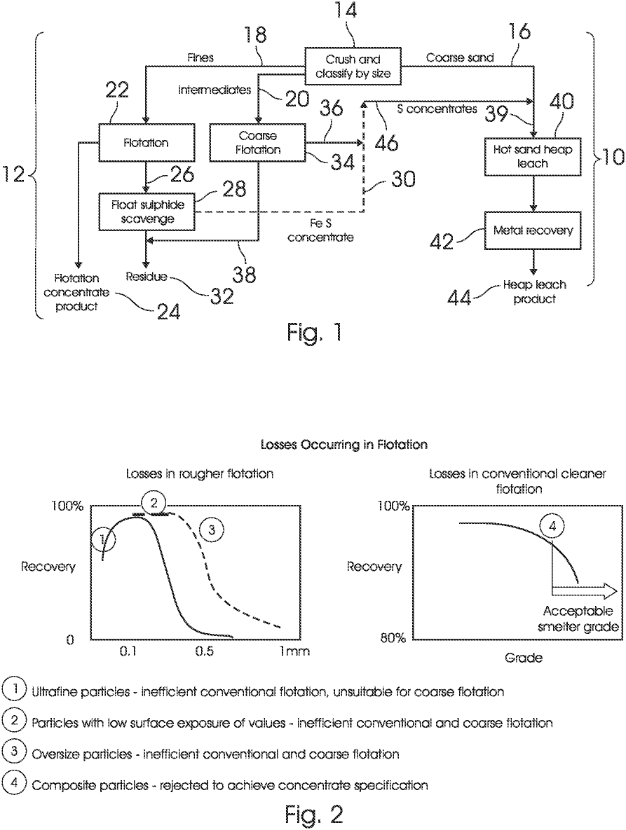

As shown in FIG. 1, which represents just one possible embodiment of the invention, the overall system can be considered in two interdependent components, a heap leach component 10 and a flotation component 12, each of which contributes benefits to the other.

These two components of the invention will be described separately, albeit that the invention and the benefits arising, requires the combination both. For example, a low-grade concentrate containing mostly sulphides is blended into the sand heap leach to provide acid and thermal enhancement to the heap leach. At the same time, the flotation of such a low-grade concentrate enables the enhancement of the flotation recovery, with transfer of some of the values that would normally be lost in the flotation tailings back into the sand heap leach for subsequent leaching.

Firstly, to describe the heap leach component. The amount of low-grade concentrate that can be transferred, and hence the additional flotation recovery, is constrained by the macro-permeability of the sand heap, where less than 10% of the blended heap can be of a size less than 75 microns.

In one embodiment incorporating both conventional and coarse flotation, ore is crushed to a particle size P₈₀ between 0.5 and 15 mm and classified 14 by size to produce a coarse sand fraction 16, a fines fraction 18 and an intermediates fraction 20.

The coarse sand fraction 16 may have a particle size (P₈₀) of around 1-10 mm, the finer fraction 18 may have a particle size (P₈₀) of around 0.1-0.2 mm, and the intermediate size fraction 20 may have a particle size (P₈₀) of around 0.25-0.5 mm. The finer fraction 18 is subjected to conventional flotation 22, to produce a fine flotation concentrate product 24, a fine flotation tailings 26, which is subjected to a scavenging sulphide float 28 to produce an iron rich sulphide concentrate 30, and a residue 32. The intermediate fraction 20, is subjected to coarse flotation 34, to produce a coarse flotation concentrate 36, and a coarse flotation tailings 38 which is relegated to the residue 32.

The coarse sand 16 is blended with the iron rich sulphide concentrate 30, and the coarse flotation concentrate 36, stacked and subjected to a heap leach 40, and subjected metal recovery process 42, to obtain a heap leach product 44. Where the concentrate product (24) from the fine flotation is of a lower than saleable grade, e.g. for a copper concentrate it could be containing from 10-20% by weight copper, or containing deleterious elements/impurities such as arsenic or fluoride that exceed the specifications for downstream smelting, part or all may be added to the sulphide rich concentrate 30 that is blended with the coarse sand 16, and the heat generation in the heap would be further increased.

Firstly, to address the sand heap leach component in the preferred hot bioleach configuration, which enables accelerated leaching of the values, with a higher overall extraction and lower acid consumption than can be achieved by conventional heap leaching.

A combined low grade sulphide concentrate 46 from the concentrates 30 and 36, containing some sulphides from the classification sizes assigned to flotation is blended with the coarser sand fraction 16 arising from the initial classification, to form a blend 39 with the particles from the concentrate 30 or from the concentrate 30 and concentrate 36 dispersed in the blend 39, and the blend 39 is included in the sand heap leaching 40. The raised sulphur content in the heap 40 is dependent on the grind size which dictates the proportion of ore which is floated (and hence recovered in stream 30). For example, a copper ore containing 1% by weight sulphur would typically be increased to around 1.5% by weight sulphur. A nickel ore containing 2% by mass sulphur would be increased to around 3% by weight sulphur. But at a finer crush size, a greater proportion of the ore would report to flotation the sulphur content of the heap leach would be increased to say 3% and 6% respectively.

The raised sulphide content blended through the sand heap leach provides for greater oxidation of the sulphides both the reactive iron sulphides added as a concentrate and the slower leaching valuable sulphides to occur, with temperatures in the heap leach raised to well in excess of 40° C. The heat is generated by effective use of exothermic biological or chemical heap leaching of the sulphides contained in the coarse fraction of the ore, supplemented by the sulphide concentrate from flotation. This occurs throughout the heap due to blending during heap formation, thus resulting in very effective heat transfer to the remainder of the particles, leachant and air present in all parts of the heap. This elevated heap temperature, enables faster dissolution of the valuable metals from the ore and the added sulphide concentrate in the sand heap leach, for subsequent recovery of the values from the leachate by processes like solvent extraction and electrowinning or precipitation.

During the oxidation of the sulphide content of the heap using biooxidation, acid is generated by the sulphide particles, particularly when operating at a pH, usually between 1.7 and 2.5, where the dissolved ferric ion at least partially reprecipitates as a hydroxide type species. This provides for additional acid to compensate for gangue dissolution during leaching. The blending through the heap enables efficient use of this acid, in the immediate vicinity of the ore to be leached, rather than it having to be added from the top of each lift, and hence partially consumed by the time it migrates to lower parts of the heap.

For leaching systems other than the traditional biooxidation typically used for secondary copper, the presence of the extra sulphides in the low grade concentrates contributes less heat, as less of the iron sulphides are oxidised. However, these other leachants still benefit from increased recoveries of the valuable minerals which are also present in the low-grade concentrate. Examples of these alternative leaching systems are acidic copper chloride to dissolve copper ores, the bioleaching of nickel sulphides at elevated pH, and for both copper and nickel, ammoniacal solutions, and glycine operating at a basic pH. Each of these leachant systems will have its preferred concentrations of reagents and pH range for operation, as is well known to those skilled in the art.

The addition of some fine sulphide containing concentrate (< 0.3 mm) to the heap leach, within the limits of heap macro-permeability, also enhances the lateral dispersion of leachant, thus improving coverage that can be achieved throughout the heap. Again, blending of the fine ore through the heap enables the most uniform distribution of leachant.

However, the quantity of low-grade concentrate 30 that can be blended is constrained by the macro-permeability of the sand heap. Whilst addition of concentrate at small quantities is beneficial to the heap operation, the amount of slimes (<0.075 mm) that can be added back is limited by the heap permeability, usually to less than 10% and preferably less than 7% slimes (<0.075 mm) in the heap.

The low-grade sulphide concentrate 36 generated from coarse flotation component of flotation contains low levels of slimes and typically has sulphur grades of around 10%. Thus, there are no constraints on adding this coarser material to the heap. However, the low-grade iron enriched concentrate from conventional flotation typically contains around 30-50% slimes by weight. Hence the amount of low-grade iron enriched concentrate from conventional flotation, typically containing around 10-20% by weight sulphur, that can be blended into the sand heap leach is constrained to less than 15% by weight of the weight of sand in the heap.

The typical mass distributions in the initial classification 14 of the current invention results in between 10-50% being assigned to conventional flotation depending on crush size. The mass pull of the conventional flotation feed to the iron enriched concentrate fraction is around 10%. Even with 50% of ore in feed to flotation and 10% mass pull containing 50% slimes, the slimes content of the heap is only 5% of the quantity of sand, and hence the macro-permeability constraint is not breached. The flexibility to pursue enhanced extraction in flotation is entirely consistent with high macro-permeability of the sand heap.

The heat generated and hence thermal enhancement in the sand heap leach using bioleaching, is approximately proportional to the percentage of sulphides that are oxidised in the heap. Run of mine ores typically contain around 1.5-3% sulphur by weight, although this may vary significantly between resources. The classification of the ore to enable flotation and coarse flotation recovery allows for a high recovery of the sulphur from this fraction, to be added back to the remaining sand as a flotation concentrate typically containing 10-20% sulphur. By adjusting the crush size, the quantity of sulphur available to be blended in the sand heap leach can be enhanced significantly, within the constraint of heap macro-permeability.

Hence the flotation recovery and adjustment of the sulphur content required for the efficient sand heap leach, can be independently optimised.

Various embodiments of the heap leach part of the invention can be described in terms of the sulphide fractions that are recovered in flotation and added back to the sand heap leach, and secondly in the dimensional and construction flexibility that this thermal control provides to suit the particular ore, and the terrain and climate in which the heap leach is to be carried out.

In one embodiment, flotation is used to recover a conventional flotation concentrate, and the sulphide minerals such as pyrite and pyrrhotite in the ore are separately recovered from the ore in a low-grade concentrate. These iron sulphides are readily floatable, with adjusted flotation conditions. Whilst the separate sulphide concentrate in this embodiment contains predominantly pyrite or pyrrhotite, it will also scavenge an additional proportion of the valuable metal, both in solid solution in the iron sulphides and in comingled particles.

The low grade sulphide concentrate is then be blended into the bioleach heap at a rate necessary to provide the heat and acid to the heap leach, resulting in faster and additional valuable metal recovery during heap leaching.

As an example of the sulphide supplement to the heap, the pyrite content of a primary copper ore is typically around 2-4% pyrite, for an ore grade containing <1% copper. Assuming a 50% mass split of the pyrite to the size fraction assigned to flotation, and a flotation recovery of around 80% of the pyrite, the sulphide content of the sand heap leach can be almost doubled by blending the pyrite concentrate in with the sand. This added pyrite is already finely ground, and hence is even more reactive than in its original state, and suitable for heat and acid generation.

In effect, the pyrite blended into the sand leaches just as the copper concentrate previously described by US 6,802,888 when it is agglomerated on pebbles, but with several additional benefits. Firstly, the whole of the ore does not require fine grinding to form a concentrate. Secondly, as will be described in the second component of the invention, valuable metal recovery in the flotation can increased beyond that achievable when generating a normal copper concentrate. Thirdly, additional acid is generated within the heap by oxidation of the iron sulphide concentrate, thus reducing the cost of acid addition. Fourthly, the need for prior agglomeration is avoided. Furthermore, the sulphide content is blended through the heap rather than being layered on the top, and hence the heat and acid that are generated can be fully contained and utilised in the localized zone, rather than relying on leachant to carry them in part through the heap to where they are most needed. And finally, due to the free draining nature of the sand making up the heap, the heap can be used for sequential leaching, such as an initial biooxidation to dissolve copper, followed by a cyanidation of the heap to dissolve liberated gold.

The sand voidage, and consistency within the heap formed from the coarse sand fraction, is such that the addition of this extra few percent of sulphides as fines, blended into the sand heap, does not have a significant adverse effect on macro-permeability of the heap. Access by air and leachant continues to be uniformly distributed, even prior to the dissolution of much of the fine sulphide concentrate. This is unlike a traditional heap with multiple sized rocks, where the fines that were added would be selectively trapped in specific zones, hence blinding the heap.

Through adjusting the recovery of the sulphide fraction in flotation, the thermal capability of the sand heap and its acid demand can be controlled through blending the desired quantity of sulphide concentrates, to meet the specific design criteria for the ore fraction in the sand heap leach.

In a second form of embodiments, some or all of the high grade sulphide concentrate produced by flotation, or a mixed concentrate of the valuable metals and the iron containing sulphides, is also blended in with the coarse sand and hence processed by heap leaching along with the coarse sand. The valuable metal is extracted from both the concentrate and coarse sand, and subsequently recovered from the pregnant leachate. As an example of this embodiment, a copper concentrate produced by flotation could be leached at the mine site to generate copper cathode, rather than incurring the freight and treatment charges at a distant smelter.

In a third form of embodiments, the combined flotation concentrate is separately leached in agitated tanks to dissolve most of the valuable metal and generate a residue containing elemental sulphur, some of the iron sulphides, and some incompletely reacted values in the concentrate. Examples of available technologies for such leaching are well known to those skilled in the art. For example, for primary copper concentrates, they include fine grinding prior to or during leaching, pressure oxidation, acidic copper chloride leaching, vat leaching, and tank bioleaching. The leach residue containing sulphur and some unleached values is suitable for blending into the sand heap leach, for further recovery, whilst the pregnant leachant is suited for solvent extraction and electrowinning carried out in conjunction with values recovery from the sand heap leach. In this embodiment, the high extraction of values in the agitated tanks is not essential, as leaching of the residual concentrate will continue in the heap.

As noted previously, the addition of sulphides to the sand, in a ratio suited to the ore being treated, enables control of the thermal energy generated to heat the leachant and sand, and acid to offset gangue dissolution.

Variables which are available to optimise the heap leaching for a particular ore include the proportion of the sulphides added back to the sand, the rate of irrigation of the leachant, the rate of any under-heap aeration, and the addition of external thermal inputs such as adjusting the temperature of the leachant, or the under-heap air flow, or injecting into the heap directly. By varying the sulphur content of the sand and the other control variables, the optimum balance of conditions can be established for enhancing the rate of leaching, total metal extraction and acid consumption. The equisized sand particles provide even fluid flow through the heap, thus distributing the heat evenly throughout the heap, to enable effective leaching throughout the heap.

An overarching control variable for the sulphur content feeding the sand heap leach, is the size of the crush, prior to classification into fractions for flotation and sand heap leach. This crush size has multiple effects. Firstly, the crush size dictates the proportion of ore to flotation, and hence the maximum quantity of sulphides available to be added back to the sand. Secondly, it dictates the proportion of barren gangue that can be directly disposed from flotation, carrying with it both thermal mass that does not need to be heated in the sand heap and much of the acid consuming gangue. Thirdly, the crush size dictates the rate of leaching in the sand, as more of the sulphide content is highly exposed in more finely crushed sand, and thus the duration for which the ore must be maintained at the elevated temperature to achieve high extractions. And lastly, the size of sand dictates fluid flow characteristics within the heap.

Crush sizes with a P₈₀ of around 15 mm result in less than around 20% of the ore being directed to flotation, and hence the sulphide content in the heap leach can only be incrementally upgraded, and some of the values in the ore remain locked (J.D. Miller et. al., Ultimate recovery in heap leaching operations as established from mineral exposure analysis by X-ray microtomography, International Journal of Mineral Processing, Volume 72, Issues 1-4, 29 Sep. 2003, Pages 331-340). The advantage of this form of the invention is for ores in which the recovery by heap leaching generates a higher margin than the recovery by flotation.

Crush sizes of below 0.5 mm are better treated entirely by flotation, whilst sizing below around 1 mm yields only modest quantities of ore directed to the sand heap leach. At these smaller sizes, the heap leaching component of the invention is limited to a scavenging role, with most of the values reporting to the flotation concentrate. The advantage of this form of the invention is where the flotation generates a higher margin than leaching, albeit that grinding costs are higher.

The optimum crush size within these size ranges of 1-15 mm will be ore-specific, as it will be dependent on the relative revenues, recoveries and costs between the flotation and heap leaching components and any existing infrastructure at the mine site.

Typically, when bioleaching, the heap will be inoculated with a culture including thermophilic micro-organisms capable of bioleaching sulphide minerals (such as: Acidianus brierleyi, Acidianus infernus, Metallosphaera sedula, Sulfolobus acidocaldarius, Sulfolobus BC, and Sulfolobus metallicus) and is leached with a leachant comprising raffinate recycled from solvent extraction, with a pH of around 1.5. The leach is designed to be controlled at an internal temperature between 50-85° C., independent of the ambient climatic conditions. This temperature range enables the accelerated leaching of the values, without reducing the effectiveness of the biooxidation which occurs within the heap. And even more preferably for primary copper ores, the conditions will be adjusted to maintain heap temperature between 60-80° C. where more than 90% dissolution of chalcopyrite can be achieved within around 100 days (US 6,802,888, the content of which is incorporated herein by reference).

The ability to create and control the thermal properties and acid generation of the heap using the current invention increases the design and operational flexibility of the sand heap, to fit the characteristics of the particular ore, and the terrain and climate in which the heap is located. For example, the heap volume to surface area is important in conventional heap leaching, as discussed previously Mintek Heapstar™. The flexibility in sulphide content of the feed allows greater flexibility in terms of lift height and area of the sand heap. With aeration through forced air inputs via pipes located at the base and potentially other locations within the sand heap, heat distribution and redox potential of the heap can be further controlled. And the irrigation rate can also be utilised as a heat transfer medium, both within the sand heap, but also to accelerate the temperature rise by transfer to a freshly constructed sand heap.

In construction of the heap, the quantity of sulphides can be varied in different zones of the heap, by adjusting the add back rate in blending of the sulphide concentrate. This provides a further control variable to equilibrate the temperature of the heap and the lateral distribution of leachant.

The system can also process mixed sulphide or partially oxidised ores, which has significant benefit when flotation losses to produce a saleable grade of concentrate are substantial.

The second component of the current invention is the recovery by flotation, which may include both conventional flotation which typically requires a feed size of less than 0.2 mm, and coarse flotation which typically requires feed size between 0.1 to 0.4 mm to achieve high recovery. Coarse flotation can recover some values up to a size around 2 mm but with declining recoveries as the size increaes (Eriez Hydrofloat™ US 6,425,4851, the content of which is incorporated herein by reference).

One set of embodiments of the flotation component includes the use (or not) of coarse flotation to supplement conventional flotation to extend the size range at which flotation can occur. In addition to rejecting additional barren gangue, use of coarse flotation at sizes greater than optimum in terms of flotation recovery, also provides benefits to the macro-permeability of the sand heap leach. Furthermore, the ability to recover and heap leach an intermediate grade of flotation concentrate from coarse flotation enables both increased overall recovery in flotation. Whilst the ability to use the intermediate flotation concentrate to control acid and heat generation throughout the heap, enables increased heap leach recovery.

In a second set of embodiments, the concentrate generated by coarse flotation can either be added to the sand heap leach, or reground and assigned to conventional flotation for production of a saleable concentrate. Regrinding of the coarse flotation concentrate is considered where heap leach extractions are low, or where a very high sulphur content is required in the sand heap leach.

A major benefit of the current invention is the enhanced overall recovery achievable from the fraction of the classified ore fraction reporting to flotation, as a direct result of integrating this flotation with the sand heap leach.

The conventional flotation recovery typically varies from around 80-90% for easily floated copper ores, whilst more difficult ores such as nickel are typically 70-80% and can be as low as 50%. It is noteworthy that these conventional flotation recoveries are less than the extraction that can be achieved in a hot sand heap leach, even without considering the additional 5% or so smelter losses that occur in converting the flotation concentrate to metal. As noted previously, the crush size dictates the proportion of ore processed by heap leach, and that processed by flotation. This crush size can be adjusted within the range from 0.5-10 mm to optimise the recoveries achievable between heap leaching and flotation. This concept extends to an embodiment in which the residue from coarse flotation is assigned to sand heap leach for further extraction.

But over and above these recovery enhancements by assignment of a proportion of ore to the heap leach, the invention also enables a higher recovery from the ore fraction that reports to flotation. The process of the present invention thus provides a novel and inventive synergistic effect by providing a pathway for treating a flotation concentrate that would otherwise be lost to waste; whilst increasing the leaching of metals that would otherwise be lost to waste.

This increase in flotation recovery results from a reduction in the different forms of flotation losses that would normally report to the flotation residue. These various forms of losses are illustrated schematically in FIG. 2.

Comminution and classification generate a distribution of particle sizes feeding the flotation. Losses to the conventional rougher float residue include: 1) particles of valuable sulphides that are well liberated but so fine that attachment of bubbles to the sulphide surface is difficult; 2) losses of oversize valuable sulphides that are too heavy or have insufficient exposure for an attached bubble to rise through the froth layer designed to prevent overflow of the gangue; 3) losses of particles in which the valuable sulphide is largely surrounded by iron sulphides or in solid solution; since conventional flotation conditions are set to reject iron sulphides; and 4) the valuable sulphides that are either poorly exposed or composite in nature, and after being floated in the roughers are rejected in the cleaner flotation process, required to meet smelter specifications for valuable metal content.

The magnitude of these four forms of flotation loss will be different for each ore, but all are significant contributors to overall flotation losses. The upside in recovery in the ore assigned to flotation, that is achievable if these forms losses could be minimized is apparent; and has been the subject of innumerable publications and patents claiming different chemical systems, comminution and classification methods and flotation machines. However, the recoveries remain at these levels in all commercial operations.

The current invention of combining flotation with sand heap leaching enables reduced flotation losses in all four categories, by the formation of the low grade concentrate, and its add-back to the heap leach.

The crush size for the current invention is coarser than that for flotation, due to the alternative processing route for the sand heap leach fraction of the ore. Thus, the percentage of the valuable sulphide particles in the flotation feed that have been ground too finely during comminution, i.e. loss 1, is reduced.

For those particles that are too large for highly efficient flotation, typically those below around 10% surface exposure (J.D. Miller et. al., Significance of exposed grain surface area in coarse particle flotation of low-grade gold ore with the Hydrofloat™ technology, Geology, 2016, the content of which is incorporated herein by reference) the current invention allows most of this size fraction to be selected into the coarse flotation concentrate for heap leaching. For example, the p50 for classification between coarse flotation and sand heap leach can be adjusted such that only a small proportion of the size distribution to flotation is too coarse for high recovery in coarse flotation. Hence loss 2 is reduced.

Due to microcracking that occurs, even in those rare particles in which the values are almost totally locked in gangue, leachant can still gain access. Hence leaching provides a much lower source of oversize losses, than if the same ore where assigned to coarse flotation, and constitute a reduction in loss 2 at the upper end of the coarse flotation size range.

For the values that are in solid solution or composite form with the iron sulphides, they can be recovered along with the sulphide concentrate by adjusting the conditions to encourage iron sulphide flotation. In this concentrate, at least a significant proportion of the values that would be lost in flotation will be added back to the heap leach, to adjust the thermal properties of the heap. In the heap, they will then be leached along with the iron sulphides. This also reduces loss 3.

And lastly, the values that are present as composites and normally rejected as part of the cleaning process to produce smelter grade concentrate, can be scavenged along with the iron sulphides by increasing mass pull. This combined iron and valuable metal sulphide concentrate assigned to the heap leach where the values can be dissolved.

Elimination of this form of loss 3 and 4 is particularly advantageous where the ore is difficult to form a saleable value concentrate.

So, flotation losses of all forms can be reduced relative to that experienced in conventional flotation by using the current invention.

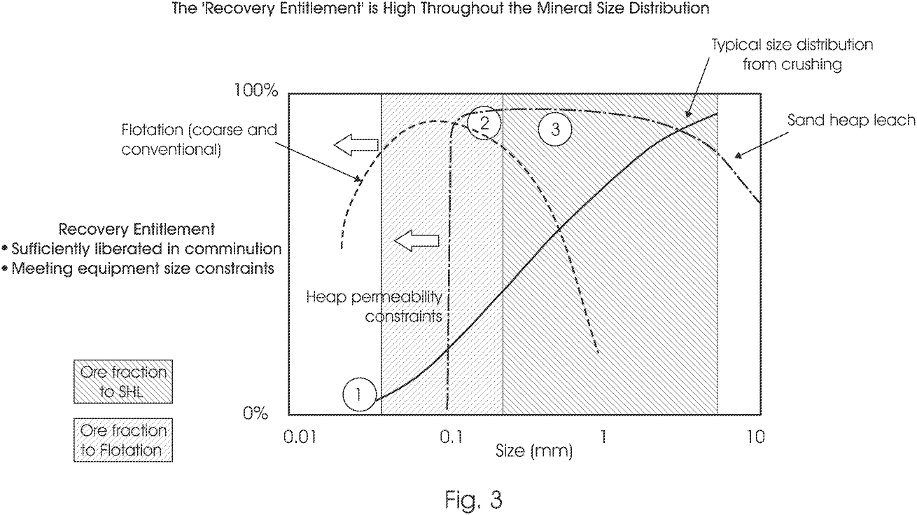

FIG. 3 illustrates the significant overlap in the size range where both coarse flotation and heap leach can achieve high recoveries. This enables some degree of inefficiency in classification between the fraction for heap leaching and the fraction for flotation, without significant loss in system recovery. And for any selected crush size, the optimum classification size between assignment to flotation and assignment to sand heap leach will be a function of ore type and classification method and the margin achievable for the alternative products from flotation and leaching. The ore type defines the maximum size at which high recovery can be achieved by conventional or coarse flotation. The classification method defines the proportion of fines which are mis-assigned to the sand heap leach, and hence reduce heap permeability. The P₅₀ of this classification between flotation and heap leach is between 0.15 and 0.5 mm, and preferably around 0.20-0.35 mm, depending on ore type.

A primary copper ore which would normally have a flotation recovery of around 85%, can be increased to between 90-95% recovery simply by operating flotation and coarse flotation in the ideal size regime, and with co-flotation of the low grade concentrate and subsequent recovery by leaching, of the iron sulphides.

Nickel sulphide flotation recoveries, where selectivity of pentlandite over pyrrhotite is difficult, can be increased even further, and the nickel typically contained in solid solution with pyrrhotite can be recovered by flotation and add back to the heap for leaching. For example, this flexibility provided by leaching a low-grade concentrate typically increases flotation recoveries of ultramafic nickel resources from around 50% typically up to around 70-85%

For mixed sulphide ores where the flotation concentrate is unsuited to most smelters which are designed for recovery of a particular metal, the heap leach allows flexibility for forming a high grade concentrate at modest recovery and heap leaching the low grade concentrate with separation of the values in the pregnant leachate, prior to electrowinning.

And for ores in which heap leaching can be achieved by use of chemical rather than biologically enhanced leachants, most of the enhanced recovery benefits of the current invention are equally applicable.

As examples, acidic copper chloride leaching of primary copper ores will benefit from the current invention through the increased flotation recovery, and the extra heat generated in the heap through the oxidation of the additional soluble sulphides in the heap. Or for the ammonia leaching of a low-grade nickel ore, similar enhanced flotation recoveries and thermal enhancement can be achieved.

A further embodiment of the invention is the processing of transition ores between the supergene and hypogene components of a copper orebody. The oxidised and secondary copper ores are usually crushed and processed by conventional heap leaching, in which recoveries in the upper supergene areas are typically around 80%. As the mine becomes deeper, the ore transitions to contain progressively more chalcopyrite. This chalcopyrite is not recoverable by leaching unless the temperature of the heap exceeds around 55° C., and hence the heap leach recovery drops typically into the region of 50-60%. If the resource is very rich at depth, the heap leaching can be abandoned and replaced by milling and flotation assets. Otherwise the operation is abandoned altogether as the heap leach recovery does not justify the cost of mining and processing. By using the process of the invention, as the mine transitions out of any oxide ore and into the supergene and hypogene, a small flotation plant can be introduced to complement the heap leach. This flotation plant will process the fines produced in crushing, with recoveries as either a saleable flotation concentrate or a low grade concentrate in excess of 90%. The low grade sulphide plant will generate sufficient sulphide to enable hot bioleaching of the chalcopyrite content, implying a heap leach recovery which exceeds 80%. The benefits are higher extractions than can be obtained by either flotation or heap leaching, whilst eliminating the need for milling at any time through the life of mine.

In summary, the current invention in its multiple embodiments, can be applied to maximise recovery of those values of all ores that are amenable to both flotation and leaching. It also accelerates leaching by enabling the heap leach to achieve elevated temperatures. It is applicable to sulphide ores of copper and nickel, and also mixed sulphide ores, and also including gold ores where gold is partially locked in iron sulphides. In addition to the enhanced recovery, comminution requirements to prepare the ore for subsequent recovery of the values are reduced, from fine grinding to fully liberate the valuable sulphides, to those sizes typically associated with heap leaching.

### NON-LIMITING EXAMPLES OF THE INVENTION

### Example 1 - Processing a Nickel Sulphide Orebody

An ultramafic ore containing nickel at a grade of 0.4% Ni, present mainly as sulphides but with a significant component of nickel in silicates, can be processed by conventional flotation to a saleable concentrate with 50% flotation recovery.

This same ore can be crushed to a P₈₀ of 4 mm, and cycloned or screened at 0.15 mm, to generate 25% of the ore at a size of less than 0.15 mm. This fine fraction (with a P₈₀ of around 0.15 mm) is subject to flotation under the same conditions as used conventionally, to produce a similar saleable concentrate. The flotation tails is then refloated in a second stage at a lower pH of 5, such as to float the iron sulphides. With a high mass pull to the low-grade concentrate of 25% of the flotation feed, the nickel recovery is enhanced. Ni recovery to the flotation recovery of nickel to the saleable concentrate is 50% with 25% recovery in the form of a low-grade iron rich concentrate.

The low-grade concentrate (6% of the original ore mass) is blended with the screen oversize, (75% of the original ore with a P₈₀ of around 4 mm and is stacked and subjected to bioleaching in heaps. The heap contains around 5% of slimes less than 0.075 mm, and is sufficiently permeable to irrigation at 1 L/m²/h. The heap contains 80% of the nickel in the original ore, with surface exposure due to the size less than 4 mm, enabling a leach entitlement in excess of 90%. The leach conditions are consistent with those of Cameron using sulphide oxidising bacteria adapted to the elevated pH (Cameron et. al. Elevated-pH bioleaching of a low-grade ultramafic nickel sulphide ore in stirred-tank reactors at 5 to 45° C., Hydrometallurgy, Volume 99, Issues 1-2, October 2009, Pages 77-83, the content of which is incoprporated herein by reference), with the leachant adjusted to pH 5. Nickel extraction after 200 days is 80% of the contained nickel in the blend.

The combined nickel recovery between flotation to form a saleable concentrate and leaching is 75%, compared to conventional flotation recovery of 50%.

### Example 2 - Processing a Primary Copper Gold Ore

A primary copper gold ore with a grade of copper (0.59%) and gold (0.24gpt) yields a conventional flotation recovery of 80% Cu and 38% gold contained in the ore into a saleable copper concentrate, representing 2% of the ore mass. A further 5% of the copper and 21% of the gold can be recovered from the flotation tailings into a pyrite concentrate stream representing 8% of the ore mass, and a cleaner tails containing 6% of the copper and 30% of the gold in ore. The cleaner tailings and the pyrite concentrate, totaling 15% of the ore mass, can be ground finely (P₈₀ of 0.02 mm) and agitation leached, to recover 60% of the contained gold, albeit with a high cyanide consumption due to the soluble copper. Thus, the total recovery of values from the ore using conventional technology is 80% Cu and almost 70% of the gold. (as has been described in Ghaffar et. al. 2016 KSM (KERR-SULPHURETS-MITCHELL) Prefeasibility Study Update and Preliminary Economic Assessment, Report to: KSM Project Seabridge Gold Northwestern British Columbia, Canada, the content of which is incoprporated herein by reference).

The same ore can be crushed to <5 mm in a HPGR and air classified into 3 fractions, <0.15 mm (with a P₈₀ of around 0.15 mm) containing 20% by weight of the ore, 0.15-0.35 mm (with a P₈₀ of around 0.35 mm) representing 10% of the ore, and >0.35 mm (with a P₈₀ of around 4 mm) representing 70% of the ore.

The conventional rougher and cleaner stages of flotation on the fraction less than 0.15 mm yields a saleable copper concentrate with 82% recovery of copper and 38% recovery of gold, representing a recovery of 18% of the copper and 8% of the gold in the original ore.

The rougher tailings from conventional flotation are refloated at a modified pH of 4, to produce a pyrite concentrate containing 5% of the mass of the ore, and with a recovery of 5% of the copper in the rougher tailings and 21% of the gold. This pyrite concentrate contains 1.5% of the copper in the original ore and 2.5% of the original gold.

The cleaner tailings from the conventional flotation, contain 1.5% of the original copper and 6.5% of the original gold.

The cleaner tailings and the pyrite concentrate representing a total of 4% of the initial mass of ore, are assigned to be blended with the >0.35 mm fraction from air classification.

The final tailings from conventional flotation is disposed and contains 16% of the mass of the original ore and contains 1.5% of the copper and 2.5% of the Au in the original ore.

The fraction of ore in the size between 0.15-0.35 mm is floated in a Hydrofloat™ device at pH 4, to float both copper and gold into a coarse flotation concentrate. The teeter flow is adjusted to achieve a mass pull of 25%, representing 2.5% of the original ore mass to a low grade coarse flotation concentrate. Recoveries to this coarse flotation concentrate are 91% Cu and 85% Au. The coarse flotation concentrate containing 2.5% of the mass of the original ore, is also assigned to be blended with the oversize ore from air classification.

The final coarse flotation tailings which represent 7.5% of the mass of the original ore, and contain 1 % of the copper and Au in the original ore, are disposed.

The blend of flotation cleaner tailings, flotation pyrite concentrate, coarse flotation concentrate, and oversize from air classification is stacked and heap bio-leached with a leachant pH of 1.5, and an iron concentration of 2 g/L, with a heap temperature of 65° C., for 150 days. Irrigation rates are 1L/m²/h and air is injected to the base of the heap. Copper extraction is 85%, while no gold is dissolved. Most of the iron sulphides are also dissolved, thus liberating the contained gold.

The heap is then washed to remove soluble copper and iron; and then irrigated for another 50 days with a 0.5 g/L sodium cyanide solution at pH 10.5. Gold extraction is 90%.

The final residue from heap leaching represents 80% of the original ore and contains 12% of the copper and 9% Au in the original ore and is disposed.

Through application of the invention to this ore overall copper extractions are 85% Cu and 87% Au into forms from which they can be readily recovered; compared to conventional flotation, fine grinding and agitation leaching which achieves an equivalent of 80% Cu and 70% Au recovery.

### Example 3 - Processing a Transition Copper Ore

Two size fractions of a transition copper ore with a sulphide grade of 1.2% were prepared by crushing the ore to -2.4 mm and -6.7 mm respectively. The ore contained about 30-40% of the contained copper as chalcopyrite and pyrite represented about 75% of the total sulphide content of the ore. The crushed fractions were screened at 0.425 mm to yield a coarse sand oversize with relatively narrow particle size distributions as described in Table 1.

TABLE 1

Particle size characteristics of column leach samples

| Sample Name | P₁₀ (mm) | P₅₀ (mm) | P₈₀ (mm) | P₉₀ (mm) | P₉₀/P₁₀ |
|---|---|---|---|---|---|
| -2.4 mm | 0.58 | 1.43 | 1.95 | 2.16 | 3.7 |
| -6.7 mm | 0.51 | 3.30 | 5.24 | 5.97 | 11.7 |

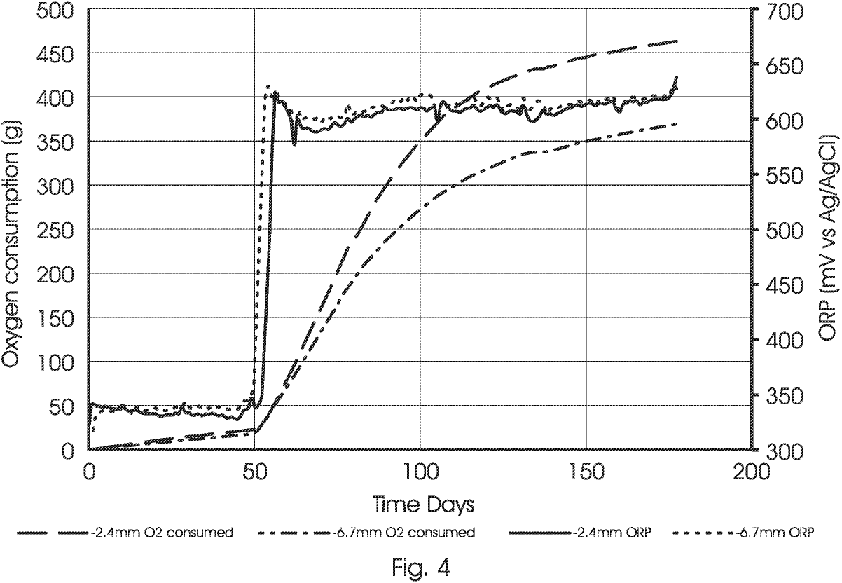

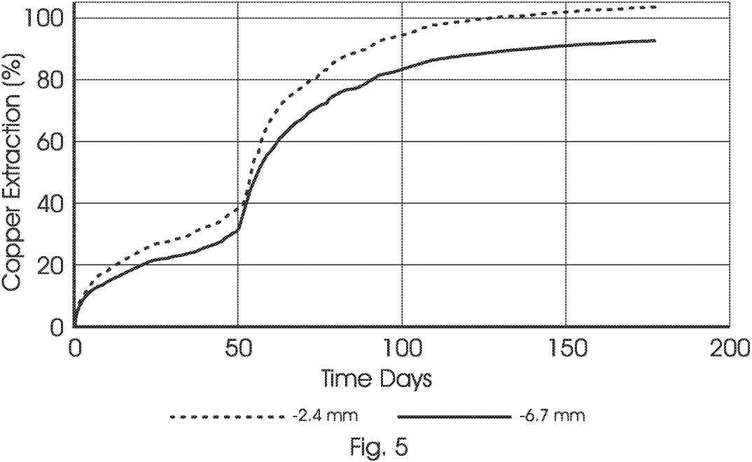

These fractions were leached in a 1 m column at 68° C. that had been inoculated with a consortium of extreme thermophilic archaea. Air was fed into the base of the columns and the oxygen content of the off-gas was measured to determine the overall oxygen utilization. After an acclimatization period of about 50 days, a rapid increase in bacterial activity was observed as noted by a sharp increase in oxygen consumption and a corresponding step change in solution potential (FIG. 4). Prior to this, more reactive secondary sulphides and minor oxide phases were dissolved. With the increase in bacterial activity, the rate of copper extraction increased markedly as shown in FIG. 5 (which shows Indicative copper extraction rates -solution analysis only) and total extraction by solution assays suggested extractions in excess of 90% were achieved for both fractions. This further supported by the agreement between the total oxygen consumption and feed sulfide content.

The sample mineralogy and the oxygen consumption profiles were used to estimate the total rate of sulphide oxidation and the corresponding heat generation power density. Over the period from 50-100 days, the average power density was 45 W/m³ and 35 W/m³ for the -2.4 mm and -6.7 mm fractions respectively. Even for this comparably low total sulphide grade, such heat generation power densities, if effectively harnessed within a sand heap leach design, would enable continuous autothermal operation at temperatures where chalcopyrite leaching is rapid, i.e., >55° C. With add-back of a low grade concentrate from conventional flotation and a coarse flotation concentrate, both of which would have high sulphide contents, the heat generation would be further increased.

The -0.425 mm fractions that were produced from crushing, were further classified at 0.15 mm to generate a further two size fractions - a finer fraction that is suited for conventional flotation and a coarser fraction that is suited for coarse particle flotation. The -0.15 mm fraction from the original -2.4 mm sample was subjected to rougher flotation in a 2.5L laboratory flotation cell under conditions aimed at maximizing sulphide recovery. The overall concentrate produced from this test had a total sulphur grade of 10.6% with a recovery of sulphur of 95.2%. The mass pull was 17.2% and the copper recovery was 87%.

In another test, different samples of the same ore used in the previously described leaching and flotation tests was prepared by grinding and classification of the sample to a P₈₀ of 0.37 mm. These samples had a sulphur head grade of 1.9-2.9%. A laboratory scale 6″ HydroFloat™ was used to recover a coarse concentrate from the feed fraction. The concentrate produced had an overall sulphur grade of 8-12% and a sulphur recovery of 80-90%. The mass pulls were in the range of 13-20% and copper recovery varied between 85-95%, depending on the ore mineralogy.

When combining the results of the leaching and flotation tests described above, the finer fractions that are generated during crushing can be effectively treated by flotation to recover the copper values and sulphur. Returning the resulting fine- and coarse-flotation concentrates back to the sand heap, would not significantly decrease the heap permeability as the total mass contribution is about 3-6% of the original ore mass. These high-grade concentrates would boost the copper and sulphur grades in the sand to be leached, improving the heat generation potential. Ultimately, the minimum sulphur grade for a particular ore, associated with the heat generation rate required for effective dissolution of the values, will be determined by the heap design, mineralogy, leaching chemistry system, particle size and required irrigation and aeration rates.

1-72. (canceled)

73. A method for processing a sulphide ore containing metal values in which:
the ore is comminuted to a P₈₀ from 0.5 to 15 mm, and classified:
into a fraction with a particle size P₈₀ of less than 0.25 mm suitable for fine flotation; and
an oversize fraction;
the fraction suitable for fine flotation is subjected to fine flotation to produce a concentrate product containing metal values and residue which is subjected to a scavenging sulphide float to produce a concentrate containing metal sulphide values and iron sulphides, and a fine flotation residue;
the concentrate containing iron sulphides or a leached residue thereof and possibly including concentrate product from the fine flotation, is blended with the oversize fraction to obtain a blended ore; and
the blended ore is stacked and subjected to a heap leach process in which the heap is irrigated with a leachant to obtain a pregnant leachate containing metal values.

74. The method claimed in claim 73, wherein the ore contains sulphides containing copper, nickel, zinc, and/or gold value metals, including ore with gold as a primary or coproduct.

75. The method claimed in claim 73, wherein the concentrate containing iron sulphides or a leached residue thereof includes concentrate product from the fine flotation.

76. The method claimed in claim 73, wherein the ore is comminuted to a P₈₀ from 1 to 10 mm, or a P₈₀ from 2 to 8 mm, or a P₈₀ from 2 to 6 mm.

77. The method claimed in claim 73, wherein the oversize fraction from the first classification has a particle size P₈₀ up to 15 mm, or a particle size P₈₀ up to 10 mm, or a particle size P₈₀ up to 8 mm, or a particle size P₈₀ up to 6 mm.

78. The method claimed in claim 73, wherein the fraction suitable for fine flotation has a particle size P₈₀ of 0.1 to 0.25 mm, or a particle size P₈₀ of 0.15 to 0.2 mm.

79. The method claimed in claim 73, wherein the fraction suitable for fine flotation comprises 10 to 35% by weight of the comminuted ore, and the oversize fraction comprises 90 to 65% by weight of the comminuted ore, the fraction suitable for fine flotation comprises 15 to 25% by weight of the comminuted ore, and the oversize fraction (16) comprises 85 to 75% by weight of the comminuted ore.

80. The method claimed in claim 73, wherein the residue is subjected to the scavenging sulphide float at a modified pH of about 4 to 5.

81. The method claimed in claim 73, wherein the concentrate contains 4 to 6% of the mass of the ore.

82. The method claimed in claim 73, wherein the concentrate containing iron sulphides has a particle size P₈₀ of 0.1 to 0.25 mm, or a particle size P₈₀ of 0.15 to 0.2 mm.

83. The method claimed in claim 73, wherein the concentrate containing iron sulphides has a sulphur grade of 5 to 35% by weight, or a sulphur grade of 10 to 35% by weight, or a sulphur grade of 10 to 25% by weight, or a sulphur grade of 10 to 20% by weight.

84. The method claimed in claim 73, wherein the blended ore has a sulphur content of greater than 1% by weight, or a sulphur content of greater than 2% by weight.

85. The method claimed in claim 73, wherein the concentrate and possibly including concentrate product from the fine flotation, is blended with the oversize fraction in an amount to limit the amount of particles with a size <0.075 mm to less than 10% by weight in the blended ore, or the concentrate and possibly including concentrate product from the fine flotation, is blended with the oversize fraction in an amount to limit the amount of particles with a size <0.075 mm to less than 7% by weight in the blended ore.

86. The method claimed in claim 85, wherein the stacked blended ore is sufficiently permeable to irrigation at greater than 0.5 L/m²/h, or is sufficiently permeable to irrigation of 1 L/m²/h or greater.

87. A method for processing a sulphide ore containing metal values, in which:
the ore is comminuted to a P₈₀ from 0.5 to 15 mm, and classified:
into a fraction with a particle size P₈₀ of less than 0.2 mm suitable for fine flotation;
a fraction with a particle size P₈₀ of greater than 0.2 mm and less than 1 mm suitable for coarse flotation;
and an oversize fraction;
the fraction suitable for fine flotation is subjected to fine flotation to produce a concentrate product containing metal values and residue which is subjected to a scavenging sulphide float to produce a concentrate containing some metal sulphide values and iron sulphides, and a fine flotation residue;
the fraction suitable for coarse flotation is subjected to coarse flotation to obtain a coarse flotation product containing metal values, and a coarse flotation residue; and
the concentrate containing iron sulphides or a leached residue thereof and possibly including concentrate product from the fine flotation is blended with the oversize fraction to obtain a blended ore; and
the blended ore is stacked and subjected to a heap leach process in which the heap is irrigated with a leachant to obtain a pregnant leachate containing metal values.

88. The method claimed in claim 87, wherein the concentrate containing iron sulphides and possibly including concentrate product from the fine flotation, and all or a portion of the coarse flotation product are blended with the oversize fraction, to obtain the blended ore (39), or the concentrate containing iron sulphides and possibly including concentrate product from the fine flotation, is blended with all or a portion of the coarse flotation product, and then blended with the oversize fraction to obtain a blended ore.

89. The method claimed in claim 88, wherein the concentrate containing iron sulphides and possibly including concentrate product from the fine flotation, is blended with the coarse flotation product and the oversize fraction (16) in an amount to limit the amount of particles with a size <0.075 mm to less than 10% by weight in the blended ore, or the concentrate containing iron sulphides and possibly including concentrate product from the fine flotation, is blended with the coarse flotation product and the oversize fraction in an amount to limit the amount of particles with a size <0.075 mm to less than 7% by weight in the blended ore.

90. The method claimed in claim 89, wherein the stacked blended ore is sufficiently permeable to irrigation at greater than 0.5 L/m²/h, or greater than at 1 L/m²/h or greater.

91. The method claimed in claim 87, wherein the concentrate containing iron sulphides is blended with all or a portion of the coarse flotation product, and then blended with the oversize fraction to obtain the blended ore.

92. The method claimed in claim 87, wherein the concentrate containing iron sulphides is blended with all or a portion of the coarse flotation product and the blend is leached in agitated tanks to generate a residue containing elemental sulphur and iron sulphides which is blended with the oversize fraction.

93. The method claimed in claim 73, wherein the heap leach process is a biooxidation leach process, or a chemical leach process.

94. The method claimed in claim 93, wherein the heap leach is a biooxidation leach process, the heap is inoculated with thermophilic microorganisms and irrigated with a leachant.

95. The method claimed in claim 94, wherein the leachant is a sulphuric acid containing raffinate from a solvent extraction process.

96. The method claimed in claim 94, wherein the pH of the leachant is less than 2.5, or the pH of the leachant is less than 2.

97. The method claimed in claim 94, wherein, in the heap leach process, the heap has an internal temperature of between 50-85° C., or an internal temperature of between 60-80° C.

98. The method claimed in claim 93, wherein the heap leach is a chemical leach process.

99. The method claimed in claim 98, wherein the heap is irrigated with a leachant comprising for cyanide to dissolve gold, or copper chloride to dissolve chalcopyrite.
